(19) United States
(12) Patent Application Publication
(10) Pub. No.: US 2016/0291713 A1
(43) Pub. Date: Oct. 6, 2016

(54) TOUCH PANEL

(71) Applicant: GUNZE LIMITED, Ayabe-shi (JP)

(72) Inventors: Masahiro Hosoe, Ayabe-shi (JP); Keisuke Matsubara, Ayabe-shi (JP)

(73) Assignee: GUNZE LIMITED, Ayabe-shi (JP)

(21) Appl. No.: 15/066,716

(22) Filed: Mar. 10, 2016

(30) Foreign Application Priority Data
Mar. 30, 2015 (JP) 2015-069707

(51) Int. Cl. G06F 3/041

(52) U.S. Cl. CPC G06F 3/041

(57) ABSTRACT

A touch panel includes a transparent substrate, a decorative layer formed on the transparent substrate, a first hard coat layer covering the transparent substrate and the decorative layer, a second hard coat layer formed on a surface of the transparent substrate, the surface being opposite to the first hard coat layer, and a plurality of first electrodes formed on a surface of the second hard coat layer. Electrodes and wirings are formed without being affected by unevenness caused by the decorative layer, so that pattern precision of the electrodes and the wirings is high.

### CROSS-REFERENCE TO RELATED APPLICATIONS

This application claims priority to Japanese Patent Application No. 2015-069707 filed on Mar. 30, 2015. The entire disclosure of Japanese Patent Application No. 2015-069707 is hereby incorporated herein by reference.

### BACKGROUND OF THE INVENTION

1. Field of the Invention

The present invention relates to a touch panel attached to a display.

2. Description of Related Art

A touch panel is attached to each of various types of displays including a portable device such as a smartphone or a tablet. For example, as described in Japanese Unexamined Patent Application Publication No. 2009-301767 A, a touch panel that is attached to a front surface of a display with a periphery area thereof not being housed in a casing of the display is developed.

A conventional touch panel 100 shown in FIG. 8 (a) includes a transparent substrate 102, a decorative layer 104 formed on the transparent substrate 102, a hard coat layer 106 covering the transparent substrate 102 and the decorative layer 104, a plurality of transparent electrodes 108 formed on a surface of the hard coat layer 106, and an insulating layer 110 covering the transparent electrodes 108. The insulating layer 110 adheres to a display surface of a display 112 with an adhesive 114. Also, wirings 116 are connected to the transparent electrodes 108, and the wirings 116 are connected with a control driver 120 via a flexible connector 118.

The decorative layer 104 is an ink-applied layer 122 which is formed by applying ink to the transparent substrate 102. The decorative layer 104 is formed directly on the transparent substrate 102, and no extra material such as glass having the decorative layer 104 formed thereon is provided. A thickness of the touch panel 100 can be reduced, which contributes to thinning of a portable device or the like.

In a case where the decorative layer 104 has a blackish color, it is easy to make the wirings 116 invisible. In a case where the decorative layer 104 has a light color such as white, the wirings 116 may be possibly visually recognized as a result of transmission of light. Therefore, the ink-applied layer 122 is multilayered, to increase a thickness of the decorative layer 104, as shown in FIG. 8 (b). In the ink-applied layers 122, an ink-applied layer 122 formed later is overlaid on a previously-formed ink-applied layer 122 so as not to extend off the previously-formed ink-applied layer 122.

As a result of overlaying the ink-applied layers 122, the thickness of the decorative layer 104 is increased to approximately 30 μm to 40 μm in some cases. Thus, a projecting portion 124 may possibly be formed in the hard coat layer 106 due to the decorative layer 104. Presence of the projecting portion 124 in the hard coat layer 106 may probably cause reduction in pattern precision of the transparent electrodes 108 and the wirings 116.

### SUMMARY OF THE INVENTION

It is therefore an object of the present invention to provide a touch panel having a plurality of electrodes and the like formed therein with high pattern precision.

According to a preferred aspect of the present invention, a touch panel includes a transparent substrate having a first surface and a second surface, a decorative layer formed on the first surface of the transparent substrate, a first hard coat layer covering the first surface and the decorative layer at one time, and a plurality of first electrodes formed on the second surface of the transparent substrate. The first electrodes are formed on a surface of the transparent substrate, the surface being opposite to the decorative layer.

A second hard coat layer may be included between the second surface of the transparent substrate and the first electrodes, and the first electrodes may be formed on the second surface of the transparent substrate. The first electrodes are formed directly or indirectly on the transparent substrate.

The second hard coat layer covering the second surface of the transparent substrate and the first electrodes, and a plurality of second electrodes formed on a surface of the second hard coat layer may be included, the surface being opposite to the transparent substrate. The first electrodes and the second electrodes may be formed on different surfaces.

An over coat layer formed on a surface of the first hard coat layer may be included, the surface being opposite to the first surface of the transparent substrate. A surface of the over coat layer serves as a touch surface.

The decorative layer may include a plurality of ink-applied layers, and an ink-applied layer at an upper level may cover at least a periphery portion of an ink-applied layer at a lower level. The ink-applied layer at an upper level is visually recognized.

The touch panel according to the present invention has a surface with high hardness, which eliminates a need of sticking a protection sheet such as a cover glass, so that the touch panel can be made thinner and is easily applicable to a portable device. As a decorative layer and a plurality of electrodes are respectively formed on different surfaces of a transparent substrate, the electrodes and the like can be formed without being affected by unevenness caused by the decorative layer, to thereby enhance pattern precision. Hard coat layers are formed on opposite surfaces of the transparent substrate, respectively, to thereby prevent the touch panel from warping.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a sectional view of a touch panel according to the present invention;

FIG. 2 (a) is a top view of electrodes in one example;

FIG. 2 (b) is a sectional view of intersection of electrodes in one example;

FIG. 3 shows a state in which a touch panel is attached to a display;

FIG. 4 is a sectional view of a touch panel having a plurality of first electrodes and a plurality of second electrodes formed on a second surface of a transparent substrate;

FIG. 5 is a sectional view of a touch panel having a plurality of first electrodes and a plurality of second electrodes formed in different layers;

FIG. 6 shows a state in which an additional film having a plurality of electrodes formed therein is used;

FIG. 7 (a) is an enlarged view of a decorative layer including ink-applied layers which are overlaid;

FIG. 7 (b) is an enlarged view of a decorative layer in which a space is provided in ink-applied layers to form a character or the like;

FIG. 8 (a) is a sectional view of a conventional touch panel; and

FIG. 8 (b) is an enlarged view of a decorative layer of a conventional touch panel.

### DESCRIPTION OF THE PREFERRED EMBODIMENTS

A touch panel according to the present invention will be described with reference to accompanying drawings. In the drawings, each part is schematically shown, and a size of each part may vary among drawings for convenience of illustration.

### First Preferred Embodiment

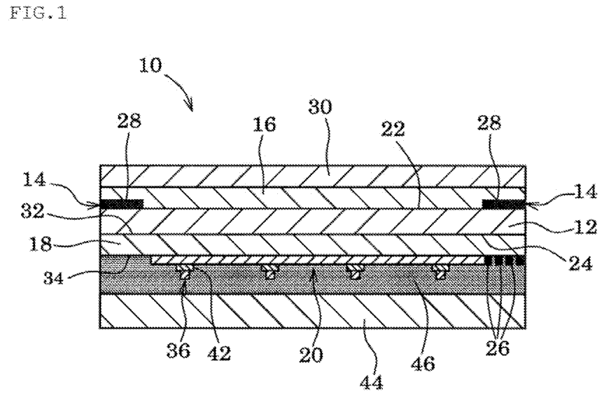

A touch panel 10 according to the present invention shown in FIG. 1 includes a transparent substrate 12, a decorative layer 14 formed on the transparent substrate 12, a first hard coat layer 16 covering the transparent substrate 12 and the decorative layer 14, a second hard coat layer 18 formed on a surface of the transparent substrate 12, the surface being opposite to the first hard coat layer 16, and a plurality of first electrodes 20 formed on a surface of the second hard coat layer 18.

The touch panel 10 is a capacitance-type touch panel attached to a front surface of a display.

The transparent substrate 12 is shaped like a sheet, and includes a first surface 22 and a second surface 24. The first surface 22 is a surface on a side of a touch surface, and the second surface 24 is a surface on a side of the display.

The transparent substrate 12 preferably includes a transparent resin material. As a material for the transparent substrate 12, cited are polyethylene terephthalate (PET), polyimide (PI), polyethylene naphthalate (PEN), polyether sulfone (PES), polyether etherketone (PEEK), polycarbonate (PC), polystyrene (PS), polyamide (PA), an acrylic resin, a cyclic olefin resin, and a material formed of a laminate including two or more kinds out of the afore-cited materials. It is noted that a term “resin” in this description is not limited to a substance, all of which is made of a polymer organic material, but includes a substance Including an inorganic material (organic-inorganic hybrid resin material). Further, flexible glass can also be used, other than the afore-cited resin materials.

Also, various kinds of functional layers such as an easily-adhering layer, an antireflection layer, an antiglare layer (uneven surface), and a damage prevention layer (hard coat layer) may be formed on each of the surfaces 22 and 24 of the transparent substrate 12.

A thickness of the transparent substrate 12 is not limited to any specific value. Considering thinning of the touch panel 10 and strength and flexibility during a manufacturing process, the thickness of the transparent substrate 12 is preferably in a range of approximately 10 μm to 500 μm, and is further preferably in a range of approximately 20 μm to 250 μm.

The decorative layer 14 is formed in a periphery area of the first surface 22 of the transparent substrate 12. The periphery area is located outer than a display area of the display, and does not detect any touch. Mien the touch panel 10 is attached to a display of a portable device such as a tablet or a smartphone, the decorative layer 14 improves an appearance of the portable device. The decorative layer 14 makes wirings 26 connected to the electrodes 20 visually unrecognizable.

The decorative layer 14 is an ink-applied layer 28 formed by screen printing or the like using a colored ink material. Thus, the decorative layer 14 can be formed more easily and at a lower cost than in a case where a metal such as aluminum or copper is provided by sputtering or the like. The decorative layer 14 may have a light color such as white although conventionally, the color of the decorative layer 14 has been typically blackish. Since the decorative layer 14 is formed by printing, a character, a mark, a pattern, or a combination thereof may be formed by combining plural colors.

In a case where the decorative layer 14 has a blackish color, the light transmittance thereof is low. Thus, forming a single ink-applied layer 28 which has a blackish color is sufficient, so that a thickness of the decorative layer 14 falls within a range of approximately 6 μm to 10 μm. Unlike this, in a case where the decorative layer 14 has a light color, the wirings 26 may probably be visually recognized due to light transmission. Thus, the ink-applied layer 28 is multilayered in some instances. The decorative layer 14 which has a light color is formed by repeatedly coating one layer on another to have three-to-five layers, so that a thickness of the decorative layer 14 is in a range of approximately 30 μm to 40 μm. The ink-applied layers 28 having different colors may be repeatedly coated on one another so that a desired color can be visually recognized.

The first hard coat layer 16 covers the first surface 22 of the transparent substrate 12 and the decorative layer 14. The first hard coat layer 16 protects the transparent substrate 12 and the decorative layer 14. The second hard coat layer 18 covers the second surface 24 of the transparent substrate 12. The second hard coat layer 18 protects the transparent substrate 12. The first hard coat layer 16 and the second hard coat layer 18 are formed respectively on opposite surfaces of the transparent substrate 12, so that warping of the touch panel can be prevented.

Each of the first hard coat layer 16 and the second hard coat layer 18 has higher hardness than at least the transparent substrate 12. Each of the hard coat layers 16 and 18 includes a transparent material. As a material for the hard coat layers 16 and 18, an ionizing-radiation-curing resin such as an ultraviolet-curing resin, a thermosetting resin, a thermoplastic resin, engineering plastics, and the like can be cited, for example. An ionizing-radiation-curing resin is a preferable material because use of an ionizing-radiation-curing resin makes it easy to form a film on a transparent substrate and can easily increase pencil hardness to a desired value. For an ionizing-radiation-curing resin, a substance with an acrylate-based functional group is preferable, and polyester acrylate or urethane acrylate is further preferable. The hard coat layers 16 and 18 may include the same material or different materials.

Each of the hard coat layers 16 and 18 may have a multilayered structure. In a case where each of the hard coat layers 16 and 18 has a multilayered structure, different materials may be laminated for formation of each of the first and second hard coat layers 16 and 18. In such a case where different materials are laminated, the different materials may have different functions, respectively.

An over coat layer 30 may be provided on the first hard coat layer 16 for prevention of dirt and in view of slipperiness when touched. For the over coat layer 30, it is possible to use a material which expresses a desired characteristic by using an ionizing-radiation-curing resin including an additive such as a fluorine compound having a (meth)acryloyl group at a terminal thereof or a polysiloxane compound having a (meth)acryloyl group at a terminal thereof, for example. Also, while the decorative layer 14 may probably cause unevenness in the surface of the first hard coat layer 16, the over coat layer 30 flattens the surface of the touch panel 10. Like the hard coat layers 16 and 18, the over coat layer 30 may have a multilayered structure, and a material for the over coat layer 30 may be appropriately changed.

In the second hard coat layer 18, a surface which is in contact with the transparent substrate 12 is a first surface 32, and a surface opposite to the first surface 32 is a second surface 34. The second surface 34 is provided with unevenness which is fine enough to preserve transparency, to thereby prevent blocking when the touch panel 10 is rolled during a manufacturing process. A surface roughness Ra of the second surface 34 is in a range of approximately 2 nm to 50 nm, for example.

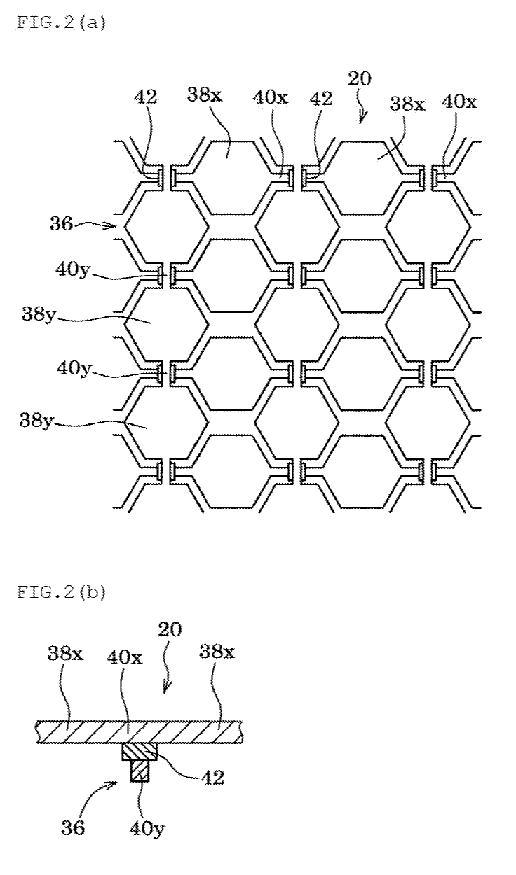

The first electrodes 20 are formed on the second surface 34 of the second hard coat layer 18. Also, as shown in FIG. 2 (a), a plurality of second electrodes 36 are formed in a direction orthogonal to the first electrodes 20. The first electrodes 20 and the second electrodes 36 are formed on the second surface 34 of the second hard coat layer 18. In light of fragileness of the transparent substrate 12, it is more preferable to form the first and second electrodes 20 and 36 on the second surface 34 of the second hard coat layer 18 as compared to a case where the first and second electrodes 20 and 36 are formed directly on the transparent substrate 12.

In the present invention, unevenness caused by the decorative layer 14 is most likely to occur in the first hard coat layer 16, not in the second hard coat layer 18. Thus, it is easy to make the second hard coat layer 18 flat, so that pattern precision of the electrodes 20 and 36 and the wirings 26 can be enhanced. It is noted that the touch panel 10 according to the present invention is applicable to not only a portable device, but also a desktop display, and thinning of the touch panel 10 contributes to miniaturization and thinning of a display.

The electrodes 20 and 36 include polygonal cells 38x and 38y, respectively, and further include connecting lines 40x and 40v, respectively. The connecting line 40x connects the cell 38x and another cell 38x, and the connecting line 40y connects the cell 38y and another cell 38y. The electrodes 20 and 36 intersect with each other at the connecting lines 40x and 40y. An insulating layer 42 is arranged between the connecting lines 40x and 40y as shown in FIG. 2 (b), and a juniper is also provided in order to keep conduction. It is noted that shapes of the electrodes 20 and 36 are not limited to shapes shown in FIGS. 2 (a) and 2 (b).

As a material for each of the electrodes 20 and 36, a transparent conductive thin film can be cited. Examples of a transparent conductive thin film include; a transparent conductive material such as an indium tin oxide (ITO), an indium oxide, an antimony-doped tin oxide, a fluorine-doped tin oxide, an aluminum-doped zinc oxide, a potassium-doped zinc oxide, a silicon-doped zinc oxide, a zinc oxide-tin oxide based compound, an indium oxide-tin oxide based compound, a zinc oxide-indium oxide-magnesium oxide based compound, a zinc oxide, and a tin oxide film; and a metal material such as tin, copper, aluminum, nickel, and chrome or a metal oxide material. Also, a transparent conductive thin film can be formed by combining two or more kinds of these materials.

Furthermore, as a material for the electrodes 20 and 36, a composite material in which an ultrafine conductive fiber including an ultrafine conductive carbon fiber such as a carbon nanotube, a carbon nanowire, a carbon nanofiber, and a graphite fibril, or including a silver material is dispersed in a polymer material which functions as a binder, can be used.

As a method of forming a transparent conductive thin film, a physical vapor deposition (PVD) process such as a sputtering process, a vacuum deposition process, or an ion plating process, a chemical vapor deposition (CVD) process, a coating process, a printing process, and the like can be cited.

A material for the electrodes 20 and 36 is not limited to a transparent conductive thin film, and a conductor wire such as a metal with an extremely small width can be formed. A width of a conductor wire is preferably equal to or smaller than 10 μm with a view to increase visibility. A width of a conductor wire is further preferably equal to or smaller than 5 μm, and still further preferably equal to or smaller than 2 μm. Also, a sufficient aperture ratio should be kept in order to ensure transparency, and a pattern pitch of each conductor wire is preferably in a range of approximately 100 μm to 1,000 μm, for example. Forming a conductor wire in a mesh shape increases the number of electric paths, which results in reduction in a surface resistivity and reduction in a risk of disconnection. In a case where an insulating area (between electrode units, for example) is formed in the electrodes 20 and 36, while all of a conductor wire may be removed, it is possible to achieve electrodes which are visually almost uniform by cutting out a part of a conductor wire.

In a method of manufacturing the above-described conductor wire, the conductor wire is formed by patterning a thin film of metal such as copper or silver with use of photolithography, for example. Alternatively, the conductor wire can be formed by various kinds of printing processes such as a gravure offset printing process and a nanoimprinting process. Conductive ink used in a case where a conductor wire is formed by a printing process is a fluid in which conductive fine particles are uniformly dispersed without flocculating in a liquid including a resin component and a solvent. As an example of a conductive fine particle included in conductive ink, a fine particle mainly including silver can be cited. Also, as an alternative to the afore-cited material for conductive ink, a conductive material which includes a conductive polymer such as poly-3,4-ethylene dioxythiophene (PEDOT) or an ultrafine conductive fiber such as a carbon nanowire or a metal nanowire as a conductor, can be used.

The wirings 26 are formed in a periphery area of the second surface 34 of the second hard coat layer 18. The periphery area has the same shape as the periphery area of the transparent substrate 12 on which the decorative layer 14 is formed. When the touch panel 10 is seen in a plane view from a side of the over coat layer 30, the decorative layer 14 and the wirings 26 overlap each other so that the wirings 26 cannot be visually recognized due to the decorative layer 14. The wirings 26 can be formed by carrying out a printing process using conductive ink such as silver ink, or by forming a film with a metal material and patterning the formed film.

The wirings 26 are connected to a flexible connector (not shown). The wirings 26 and the flexible connecter can be connected to each other by thermocompression bonding or the like via an anisotropic material. The flexible connector is connected with a controller for controlling the touch panel 10,

The second hard coat layer 18 of the touch panel 10 may be covered with an electrode protection film 44 via a pressure sensitive adhesive 46. The electrode protection film 44 protects the electrodes 20 and 36 and the wirings 26. Any transparent material can be used for the electrode protection film 44, and a material similar to a material for the transparent substrate 12 can be used, for example. Also, for the pressure sensitive adhesive 46, an optical clear adhesive (OCA) or an optically clear resin (OCR) can be used. A structure for protecting the electrodes 20 and 36 and the like is not limited to that described above. For example, a covering layer may be formed by applying an ionizing-radiation-curing resin onto the second surface 34 of the second hard coat layer 18 and curing the applied resin. Further, since the electrodes 20 and 36 and the like are covered with an adhesive 48 which will be later described, the electrode protection film 44 and the like can be omitted.

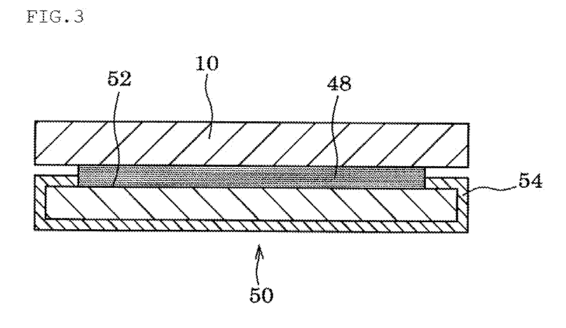

As shown in FIG. 3, the touch panel 10 adheres and is fixed to a display 50 via the adhesive 48. A portion to which the touch panel 10 adheres is a display surface 52 of the display 50. The touch panel 10 does not adhere to a bezel 54 of the display 50 in order to prevent, the touch panel 10 from being affected by warping of the bezel 54 if the warping occurs in use of the display 50. Additionally, the touch panel 10 and the bezel 54 may adhere to each other at plural local portions thereof, for reinforcement. For the adhesive 48, an optical clear adhesive or an optically clear resin can be used. It is noted that though there is a clearance between the touch panel 10 and the bezel 54 in FIG. 3 for convenience of illustration, no large clearance is provided actually.

Next, a method of manufacturing the touch panel 10 will be described. (1) The transparent substrate 12 is prepared, and the decorative layer 14 is formed on the first surface 22 of the transparent substrate 12. For formation of the decorative layer 14, a printing process such as screen printing can be employed.

(2) The first hard coat layer 16 is formed so as to cover the first surface 22 of the transparent substrate 12 and the decorative layer 14. The first hard coat layer 16 is formed by applying and curing the above-described materials. In a case where a material for the first hard coat layer 16 is an ultraviolet-curing resin, curing is achieved by ultraviolet irradiation. The over coat layer 30 may be formed subsequent to formation of the first hard coat layer 16.

(3) The second hard coat layer 18 is formed on the second surface 24 of the transparent substrate 12. The second hard coat layer 18 is formed by applying and curing the above-described materials in the same manner as the first hard coat layer 16. Although the transparent substrate 12 warps due to shrinkage which occurs when the first hard coat layer 16 is cured, formation of the second hard coat layer 18 suppresses warping of the first hard coat layer 16, the transparent substrate 12, and the second hard coat layer 18, so that the surface of the second hard coat layer 18 can be made flat. This makes it easy to form the electrodes 20 and 36, and the wirings 26 precisely.

(4) The electrodes 20 and 36 and the wirings 26 are formed on the second surface 34 of the second hard coat layer 18. The electrodes 20 and 36 and the wirings 26 are formed by vacuum film deposition or printing as described above.

In the above-described processes (1) to (4), the decorative layer 14, the hard coat layers 16 and 18, the electrodes 20 and 36, and the like may be formed by a roll-to-roll process.

(5) The wirings 26 and the flexible connector are connected to each other by thermocompression bonding or the like with an anisotropic material. In a case where a roll-to-roll process is employed in the above-described processes for manufacture, connection of the flexible connector to the wirings 26 is achieved by cutting out a necessary portion.

(6) The touch panel 10 which is shaped like a single sheet is attached to the display 50. This attachment is achieved by attaching the electrode protection film 44 to the display 50 with the adhesive 48. As the touch panel 10 is flexible and shaped like a sheet, it is possible to stick the touch panel 10 to the display 50 gradually from one side to the other side of the display 50, so that air hardly enters between the display 50 and the touch panel 10.

As described above, the electrodes 20 and 36 and the wirings 26 are formed without being affected by unevenness caused by the decorative layer 14, so that pattern precision of the electrodes 20 and 36 and the wirings 26 is high. Also, in forming the wirings 26 with ultrafine wirings in a periphery area which is narrower because of a smaller frame area, the wirings 26 can be easily formed in a desired shape. The first hard coat layer 16 can be made thinner because pattern precision of the electrodes 20 and 36 and the wirings 26 are not affected by unevenness in the first hard coat layer 16, if the unevenness is caused. High hardness of a surface eliminates a need of sticking a protection sheet such as a cover glass, so that the touch panel 10 can be made thinner. The touch panel 10 is shaped like a single sheet and is flexible, so that it is easy to attach the touch panel 10 to the display 50.

### Second Preferred Embodiment

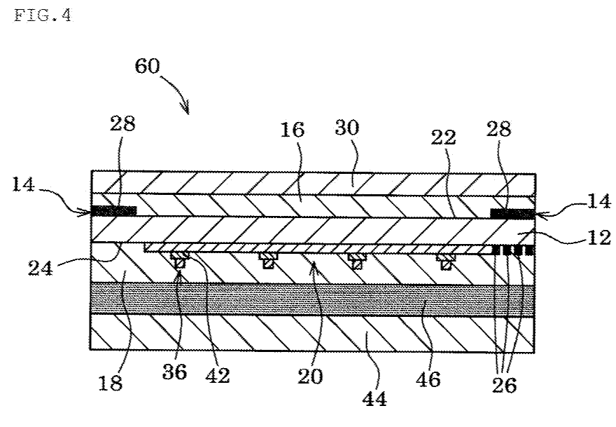

The electrodes 20 and 36 can be formed in an arbitrary layer. As in a touch panel 60 shown in FIG. 4, the first electrodes 20 and the second electrodes 36 may be formed on the second surface 24 of the transparent, substrate 12. After the decorative layer 14, the electrodes 20 and 36, and the wirings 26 are formed on the transparent substrate 12, the first hard coat layer 16 and the second hard coat layer 18 are formed. This is because forming one of the hard coat layers 16 and 18 causes the transparent substrate 12 to warp as described above. Additionally, in order to connect the wirings 26 to the flexible connector, the second hard coat layer 18 may be provided so as not to exist only at a location of connection between the wirings 26 and the flexible connector. Otherwise, connection between the wirings 26 and the flexible connector can be obtained by providing a via hole penetrating the second hard coat layer 18.

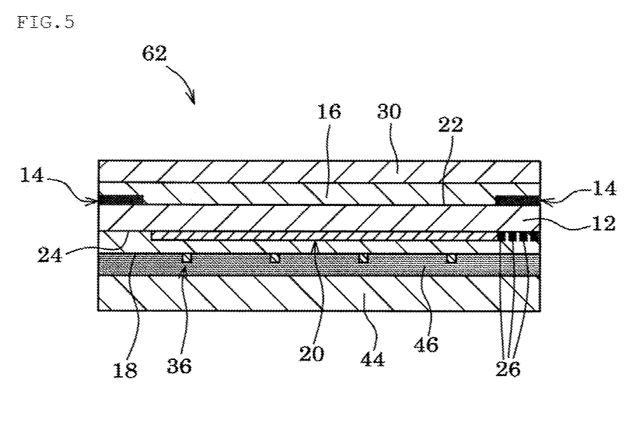

As in a touch panel 62 shown in FIG. 5, the first electrodes 20 and the second electrodes 36 may be respectively formed in different layers. The first electrodes 20 are formed on the second surface 24 of the transparent substrate 12, and the second electrodes 36 are formed on the second surface 34 of the second hard coat layer 18. Preferably, the first electrodes 20 and the wirings 26 are formed before the first hard coat layer 16 is formed. As a result of this, the first electrodes 20 and the wirings 26 can be formed before the transparent substrate 12 warps, to thereby enhance pattern precision of the first electrodes 20 and the wirings 26. Further, layers in which the first electrodes 20 and the second electrodes 36 are respectively formed may change places thereof.

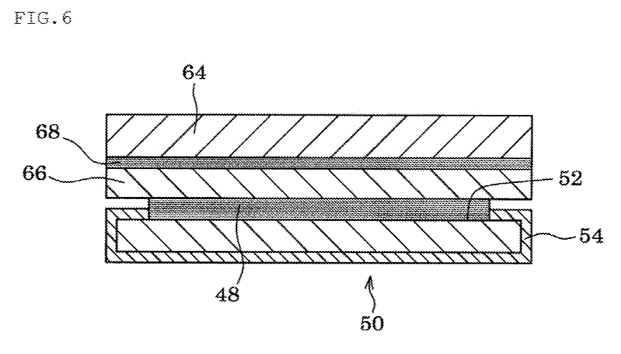

Moreover, as in a touch panel 64 shown in FIG. 6, one of the first electrodes 20 and the second electrodes 36 may be formed on either the second surface 24 of the transparent substrate 12 or the second surface 34 of the second hard coat layer 18. In this case, an additional film 66 in which the other of the first electrodes 20 and the second electrodes 36 are formed may be attached to the electrode protection film 44 with an adhesive 68.

### Third Preferred Embodiment

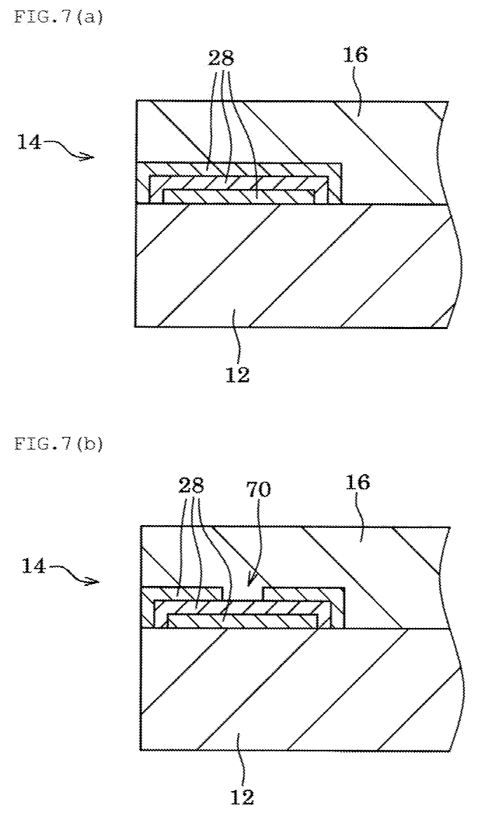

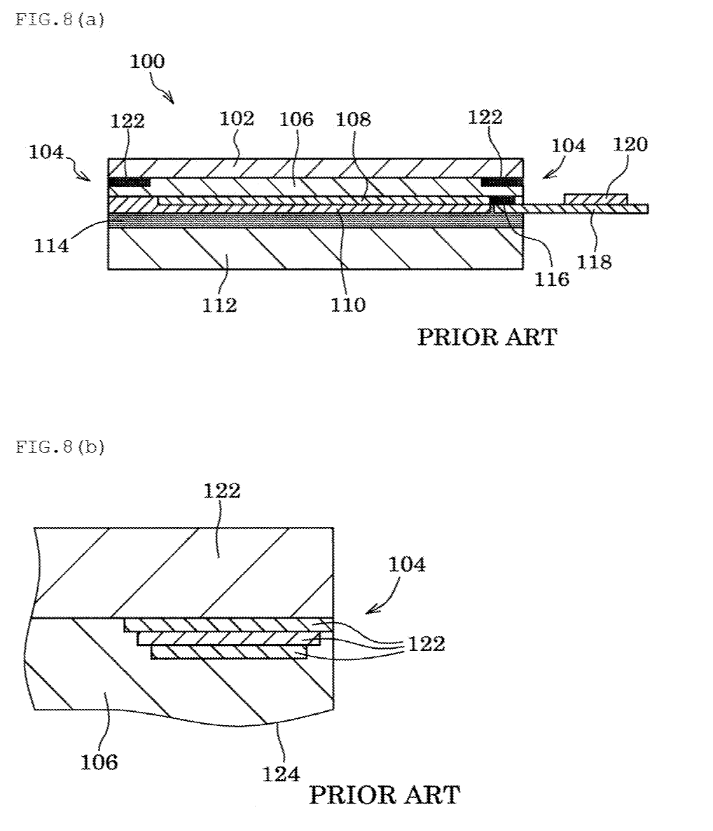

As described above, the decorative layer 14 includes a plurality of ink-applied layers 28 in some cases. If the decorative layer 104 which is described above in the related art and shown in FIG. 8 (b) is applied to the present invention, the plurality of ink-applied layers 28 should be sequentially formed on the first surface 22 of the transparent substrate 12. The ink-applied layer 28 at an upper level has a smaller area. In other words, a touch panel in a state where the touch panel shown in FIG. 8 (b) is turned upside down is provided. In this case, a stepped portion is provided between the ink-applied layers 28, and the decorative layer 14 appears to be streaked in the presence of light due to an edge of a stepped portion. This may possibly deteriorate an appearance. Thus, in the ink-applied layers 28, the ink-applied layer at an upper-level covers the ink-applied layer 28 at a lower level as shown in FIG. 7 (a), so that no stepped portion is allowed to occur between the ink-applied layers 28. It is noted that though an edge of a stepped portion has an acute angle in the drawings, the edge does not necessary have an acute angle actually because the ink-applied layers 28 are formed by screen printing or the like. By forming the ink-applied layers 28 so that an edge of a stepped portion has an obtuse angle, it is possible to make a streak more inconspicuous.

In a case where a character, a mark, a pattern, or a combination thereof is formed in the decorative layer 14, the ink-applied layer 28 having a light color is formed first at a lower level, as shown in FIG. 7 (b). Then, when another ink-applied layer 28 is formed at an upper level so as to cover the ink-applied layer 28 at a lower level, a space 70 having a shape of a character or the like is formed so as to cover the ink-applied layer 28 at a lower-level. Subsequently, in the course of formation of the first hard coat layer 16, a material for the first hard coat layer 16 enters the space 70, so that the space 70 is filled with the first hard coat layer 16. As a result of combining structures shown in FIGS. 7 (a) and 7 (b), at least a periphery portion of the ink-applied layer 28 at a lower level is covered with the ink-applied layer 28 at an upper level.

The ink-applied layer 28 at an upper level has the same color as the ink-applied layer 28 at a lower level, or has a darker color than the ink-applied layer 28 at a lower-level. The ink-applied layer 28 at the uppermost level has a darker color than the ink-applied layer 28 at the lowermost level. A character or the like having a light color is formed in a dark color including a blackish color. Hence, it becomes easy to see a character or the like.

The present invention can be implemented in embodiments to which various improvements, revisions, alterations are added based on knowledge of those skilled in this art without departing from the subject matter of the invention. Materials and the like described above are mere examples, and can be replaced with materials and the like which have similar properties and functions. The above-described preferred embodiments should not be considered solely, and the above-described preferred embodiments can be combined with one another for implementation.

What is claimed is:

1. A touch panel comprising:
a transparent substrate including a first surface and a second surface;
a decorative layer formed on the first surface of the transparent substrate;
a first hard coat layer covering the first surface and the decorative layer at one time;
a plurality of first electrodes formed on the second surface of the transparent substrate;
a second hard coat layer covering the second surface of the transparent substrate and the first electrodes; and
a plurality of second electrodes formed on a surface of the second hard coat layer, the surface being opposite to the transparent substrate.

2. The touch panel according to claim 1, further comprising an over coat layer formed on a surface of the first hard coat layer, the surface being opposite to the first surface of the transparent substrate.

3. The touch panel according to claim 2, wherein the decorative layer includes a plurality of ink-applied layers, and an ink-applied layer at an upper level covers at least a periphery portion of an ink-applied layer at a lower level.

4. The touch panel according to claim 3, wherein at least one of the first electrodes and the second electrodes includes a conductor wire.

5. The touch panel according to claim 4, wherein a functional layer is formed on the second surface of the transparent substrate.

6. The touch panel according to claim 1, wherein the decorative layer includes a plurality of ink-applied layers, and an ink-applied layer at an upper level covers at least a periphery portion of an ink-applied layer at a lower level.

7. The touch panel according to claim 6, wherein at least one of the first electrodes and the second electrodes includes a conductor wire.

8. The touch panel according to claim 7, wherein a functional layer is formed on the second surface of the transparent substrate.

9. The touch panel according to claim 1, wherein at least one of the first electrodes and the second electrodes includes a conductor wire.

10. The touch panel according to claim 9, wherein a functional layer is formed on the second surface of the transparent substrate.

11. The touch panel according to claim 2, wherein at least one of the first electrodes and the second electrodes includes a conductor wire.

12. The touch panel according to claim 11, wherein a functional layer is formed on the second surface of the transparent substrate.

13. The touch panel according to claim 1, wherein a functional layer is formed on the second surface of the transparent substrate.

14. The touch panel according to claim 2, wherein a functional layer is formed on the second surface of the transparent substrate.

15. The touch panel according to claim 3, wherein a functional layer is formed on the second surface of the transparent substrate.

16. The touch panel according to claim 6, wherein a functional layer is formed on the second surface of the transparent substrate.
